(19) United States
(12) Patent Application Publication
(10) Pub. No.: US 2008/0138681 A1
(43) Pub. Date: Jun. 12, 2008

(54) FUEL CELL SYSTEM

(75) Inventors: Kazuyuki Ueda, Tokyo (JP); Shuichiro Saito, Yokohama-shi (JP); Akiyoshi Yokoi, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/944,755

(22) Filed: Nov. 26, 2007

(30) Foreign Application Priority Data
Dec. 7, 2006 (JP) 2006-331195

(51) Int. Cl. H01M 8/18; H01M 8/04

(52) U.S. Cl. 429/24; 429/19

(57) ABSTRACT

A fuel cell system is provided which can surely shut off fuel and stop power generation for system protection when the temperature of a fuel cell or surroundings thereof becomes higher than a predetermined temperature and can be reduced in size, and which includes a fuel cell having a power generation portion; a fuel supply portion having a fuel tank for storing fuel for supply to the power generation portion; a connecting portion configured such that a flow path provided between the power generation portion and the fuel supply portion, for supplying the fuel to the power generation portion is repetitively connectable/disconnectable; and a fuel shut-off actuator configured such that the flow path is disconnectable at the connecting portion when a temperature of at least a part of the fuel cell system becomes higher than a predetermined temperature.

### BACKGROUND OF THE INVENTION

1. Field of the Invention

The present invention relates to fuel cell systems and more particularly to a fuel cell system which can be installed in a compact electrical device such as a digital camera, a digital camcorder, a small size projector, a small size printer, or a notebook personal computer.

2. Description of the Related Art

There have been proposed various types of fuel cells and above all, a polymer electrolyte fuel cell (or proton exchange membrane fuel cell) is suitable to a compact electrical device, especially a portable device. This is because the polymer electrolyte fuel cell can be used at a temperature near ambient temperature and because the electrolyte thereof is not liquid but solid and is therefore suitable for portable use.

Further, as a fuel in a fuel cell for a compact electrical device, methanol has been hitherto used.

The main reason is that methanol is a fuel easy to store and obtain.

However, a direct methanol fuel cell using methanol has a principle disadvantage that the output per unit volume is small.

In addition, the direct methanol fuel cell also has the problems of the crossover phenomenon in which fuel methanol passes thorough a polymer electrolyte membrane and directly reacts with oxygen on an oxidizer electrode side and the phenomenon in which carbon monoxide generated in the reaction poisons and deteriorates an electrode catalyst.

Moreover, since the fuel is liquid, the orientation of the fuel cell is restricted in order to uniformly supply methanol as a fuel over the whole polymer electrolyte membrane.

Furthermore, in order to prevent the resistance of a fuel path from increasing, the fuel path needs to have a sufficient dimension. When a fuel is circulated forcibly by use of a pump or the like, there are no such restrictions. However, in the case of adopting such a system, new problems such as increase in the volume of an auxiliary machine due to the pump installation and reduction of system efficiency by corresponding power consumption for driving the pump need to be solved.

For the foregoing reasons, it is optimum that for a fuel cell which gives a large output per unit volume, hydrogen is used as a fuel.

Methods for storing hydrogen as a gas at atmospheric pressure include the followings:

A first method is a method of compressing and storing hydrogen as a high pressure gas.

A second method is a method of cooling and storing hydrogen as liquid.

A third method is a method of storing hydrogen using a hydrogen storage alloy.

A fourth method is a method of placing methanol, gasoline or the like in a fuel tank and reforming it into hydrogen for use.

A fifth method is a method of using a carbonaceous material and storing a fuel in the material at a high density.

Examples of the carbonaceous material include carbon nanotube, graphite nanofiber, and carbon nanohorn.

These carbon materials can store hydrogen in an amount of approximately 10 wt % based on the weight thereof.

Accordingly, when a fuel cell using such a carbonaceous material is employed as a power supply for a digital camera, for example, it is possible to perform image taking by a number of times which is approximately three to five times that when employing a conventional lithium ion battery.

Where a carbonaceous material is used for storing hydrogen as a fuel, the pressure inside a fuel tank needs to be kept at several MPa in order to obtain a sufficient storage amount.

On the other hand, since outside air is utilized as an oxidizer on an oxidizer electrode side, the pressure thereof is usually 0.1 MPa (1 atm).

In a fuel cell unit, when the difference between the pressure of an oxidizer supplied to an oxidizer electrode and that of a fuel supplied to a fuel electrode is large, a stress generated at the fuel cell unit becomes large. Therefore, in order to withstand the stress, the structure is restricted.

Accordingly, when supplying hydrogen to a fuel cell unit, the pressure of hydrogen needs to be reduced to approximately 0.1 MPa (1 atm).

As described above, there are various fuel cells for compact electrical devices. However, when such a fuel cell does not normally generate power, or when the temperature increases to make the power generation of such a fuel cell unstable, continuing to supply a fuel as such may degrade the power generation performance of the fuel cell or cause disadvantage due to high temperature.

However, in conventional compact electrical devices, there have been restrictions in terms of installation space or production cost, so that it has been difficult to provide a temperature sensor or the like to detect temperature or separately provide a shut-off valve to thereby shut off fuel supply.

As such a measure against heat generation, Japanese Patent Application Laid-Open No. 2004-288488 has proposed a fuel supply mechanism which is configured such that when a heat treatment apparatus generates heat at a higher temperature than a set temperature, fuel supply to the heat treatment apparatus is suppressed without performing electrical control.

As shown in FIG. 9, a power generation system includes a fuel storage module 62 and a power generation module 63. In the fuel storage module 62, a fuel vessel 67 having a supply port 68 and a supply pipe 611 is disposed. A fuel supply mechanism 660 is configured such that in a supply pipe 635 communicating with a reforming apparatus 620 as a heat treatment apparatus and with the supply pipe 611, a thermoplastic thermally-deforming substance 615 having a hole through which fuel 610 flows in an ordinary state is disposed, and when the temperature of the reforming apparatus 620 becomes a temperature higher than a set temperature, fuel supply is restrained.

In other words, the fuel supply mechanism 660 is configured such that the thermally deforming substance disposed in the supply pipe plastically deforms so as to close the hole, thereby shutting off the fuel.

Hitherto, most of compact fuel cells have been structured by reducing the size of a large fuel cell and the respective parts thereof have not been optimized when performing the size reduction.

Accordingly, a compact fuel cell will have a larger volume than a lithium battery, even when giving the same output. Therefore, it has been difficult to provide a compact, high-capacity fuel cell.

Especially, when the size reduction has been performed, as described above, such a fuel cell for a compact electrical device has been structured such that even when the fuel cell does not normally generate power, or when the temperature increases to make the power generation of such a fuel cell unstable, fuel continues to be supplied as such.

Accordingly, it has been known that there is a possibility that the power generation performance of the fuel cell may be degraded or the fuel cell system may be exposed to high temperature to result in failure of the system.

When taking measures against such abnormal heat generation, in the conventional compact electrical devices, there have been restrictions in terms of installation space or production cost, so that it has been difficult to detect temperature thereby shutting off fuel supply.

In Japanese Patent Application Laid-Open No. 2004-288488 above, the above-mentioned measures against abnormal heat generation has been taken. However, once the temperature of the reforming apparatus becomes higher than a predetermined temperature, a flow path is blocked by the plastic deformation. Therefore, even when the temperature is reduced to normal temperature later on, reusing the flow path is difficult.

Further, when using liquid fuel, fuel supply can be shut off in a relatively short period of time. However, there is a problem that when the fuel is gas, it takes much time to shut off fuel supply.

Furthermore, when the temperature of the fuel vessel increases and the temperature or pressure of fuel is increased by any abnormality, there is a possibility that the thermally deforming substance may be plastically deformed by a fuel pressure without closing the hole.

### SUMMARY OF THE INVENTION

The present invention is directed to a fuel cell system which can surely shut off fuel and stop power generation for system protection regardless of whether the fuel is gas or liquid when the temperature of the fuel cell or the surroundings thereof becomes higher than a predetermined temperature and can be reduced in size.

The fuel cell system according to the present invention includes: a fuel cell having a power generation portion; a fuel supply portion including a fuel tank for storing fuel for supply to the power generation portion; a connecting portion configured such that a flow path provided between the power generation portion and the fuel supply portion, for supplying the fuel to the power generation portion is repetitively connectable/disconnectable; and a fuel shut-off actuator configured such that the flow path is disconnectable at the connecting portion when a temperature of at least a part of the fuel cell system becomes higher than a predetermined temperature.

Further, the fuel cell system of the present invention is characterized in that the fuel shut-off actuator is provided at either one of the power generation portion and the fuel supply portion.

Moreover, the fuel cell system of the present invention is characterized in that the fuel shut-off actuator includes a device having a piston-cylinder mechanism which expands and contracts depending on temperature.

Further, the fuel cell system of the present invention is characterized in that the fuel shut-off actuator includes a substance that emits a gas accompanying phase transition caused by temperature.

Moreover, the fuel cell system of the present invention is characterized in that the substance is a hydrogen storage material for driving sealed in a hydrogen storage state.

In addition, the fuel cell system according to the present invention includes: a fuel cell; a fuel tank; a flow path for supplying fuel from the fuel tank to the fuel cell; a connecting portion provided in the flow path and configured so as to be repetitively connectable/disconnectable; a temperature sensor; and an actuator for disconnecting the connecting portion in response to the temperature sensor.

Further, the fuel cell system of the present invention is characterized in that the actuator is configured so as to also serve as the temperature sensor.

The fuel cell system according to the present invention can surely shut off fuel and stop power generation to attain system protection, regardless of whether the fuel is gas or liquid, when the temperature of the fuel cell or the surroundings thereof becomes higher than a predetermined temperature and can be reduced in size.

Further features of the present invention will become apparent from the following description of exemplary embodiments with reference to the attached drawings.

### BRIEF DESCRIPTION OF THE DRAWINGS

FIG. 1 is a schematic cross-sectional view illustrating an internal structure of a fuel cell system according to Example 1 of the present invention.

FIG. 2 is a schematic perspective view illustrating a digital camera installed with a fuel cell system according to Example 1 of the present invention.

FIG. 3 is a schematic cross-sectional view illustrating a state in which as shown in FIG. 2, the digital camera is installed with the fuel cell system according to Example 1 of the present invention.

FIG. 4 is an enlarged schematic cross-sectional view illustrating a fuel inlet 5 and a fuel outlet 6 when as shown in FIG. 2, the digital camera is installed with the fuel cell system according to Example 1 of the present invention.

FIG. 5 is an enlarged schematic cross-sectional view illustrating the fuel inlet 5 and the fuel outlet 6 when a fuel shut-off actuator according to Example 1 of the present invention operates.

FIG. 6 is a schematic cross-sectional view when the fuel shut-off actuator according to Example 1 of the present invention operates.

FIG. 7 is a schematic cross-sectional view illustrating an inner portion of the digital camera in FIG. 2 which is loaded with a fuel cell system according to Example 2 of the present invention.

FIG. 8 is a schematic cross-sectional view when a fuel shut-off actuator according to Example 2 of the present invention operates.

FIG. 9 is a schematic view illustrating a conventional fuel supplying mechanism disclosed in Japanese Patent Application Laid-Open No. 2004-288488.

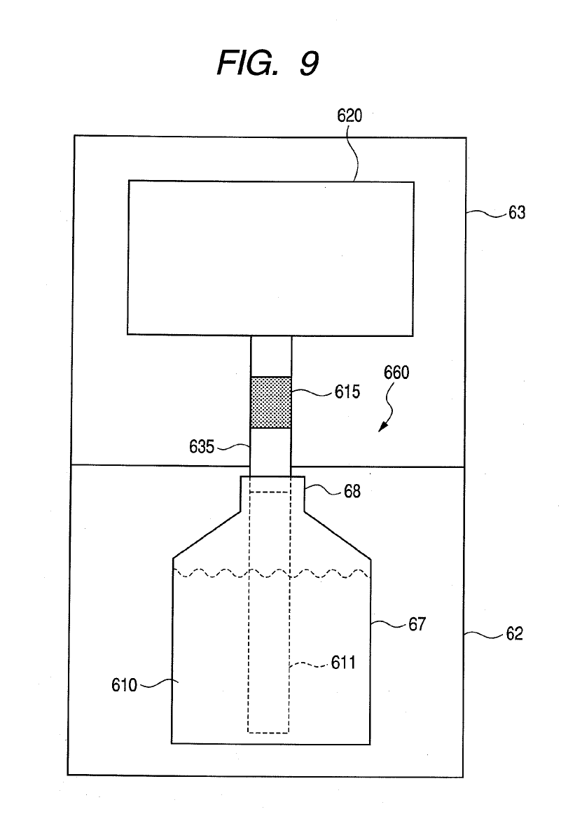

### DESCRIPTION OF THE EMBODIMENTS

Description will be given below of examples of the fuel cell system according to the present invention.

In the following embodiments concrete structural examples of the compact fuel cell system will be described, however, the present invention is not limited thereto.

### Example 1

In Example 1, description will be made on a fuel cell system to which the present invention is applied.

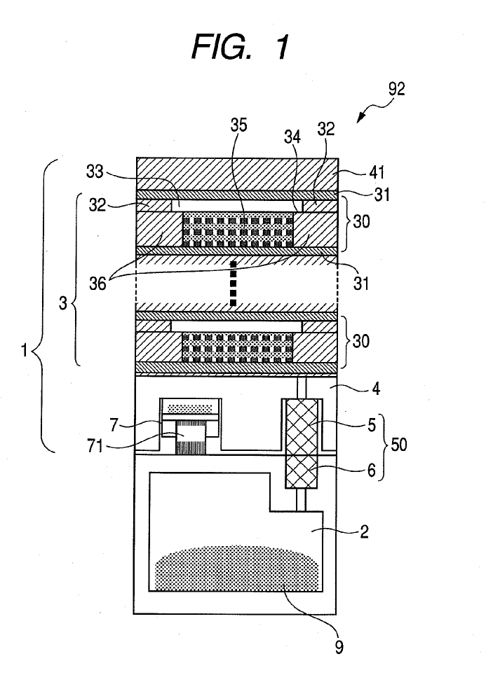

FIG. 1 illustrates a schematic cross-sectional view illustrating a fuel cell system according to the present example.

In FIG. 1, reference numeral 1 denotes a fuel cell and reference numeral 2 denotes a fuel tank constituting a fuel supply portion.

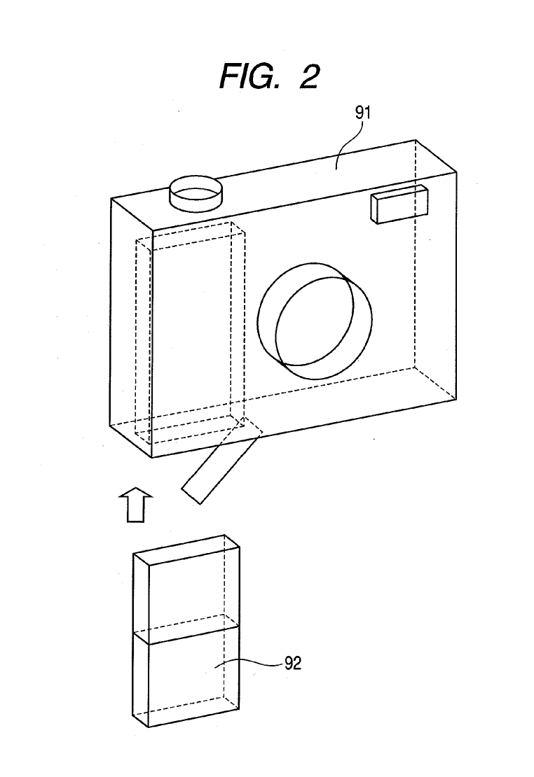

FIG. 2 is a schematic perspective view of a digital camera installed with the fuel cell system according to the present example.

In FIG. 2, reference numeral 91 denotes a digital camera and reference numeral 92 denotes a fuel cell system.

The external dimension of the fuel cell system 92 according to the present example illustrated in FIG. 2 is, for example, 30 mm long, 50 mm wide and 10 mm high and may be almost the same as the size of a lithium ion battery usually used in a compact digital camera.

As illustrated in FIG. 2, the fuel cell system 92 according to the present invention is small-sized and integrated, which provides such a shape as to permit easy assembly into the digital camera 91 as a compact electrical device.

Further, such a thin rectangular parallelepiped shape that the fuel cell system according to the present invention is assembled more easily into a compact electrical device than a thick rectangular parallelepiped shape or a cylindrical shape.

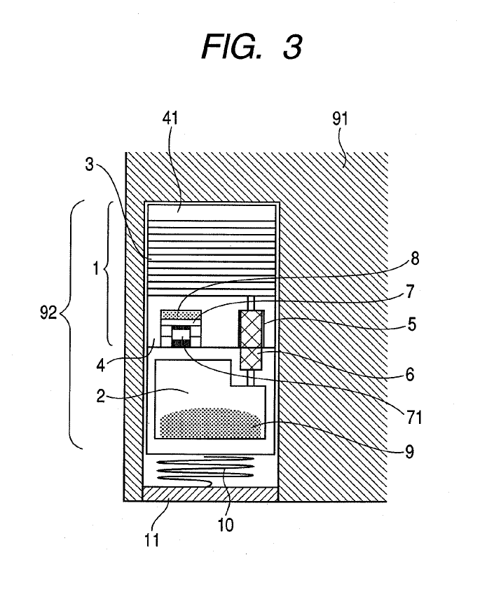

FIG. 3 is an enlarged schematic cross-sectional view illustrating an inner portion of the digital camera 91 used in the present example is loaded with the fuel cell system 92 as illustrated in FIG. 2.

In FIG. 3, reference numeral 1 denotes a fuel cell, reference numeral 2 denotes a fuel supply portion including a fuel tank (hereinafter referred to as a fuel tank 2), reference numeral 3 a fuel cell stack, reference numeral 4 an end plate, reference numeral 5 a fuel inlet and reference numeral 6 denotes a fuel outlet.

In addition, reference numeral 7 denotes a fuel shut-off actuator, reference numeral 8 the hydrogen storage material for driving, reference numeral 9 the hydrogen storage material, and reference numeral 10 denotes a pressure spring.

Further, reference numeral 11 denotes a cell lid, reference numeral 41 a top plate, and reference numeral 71 denotes a piston.

When the cell lid 11 is closed after the fuel cell system 92 has been inserted into the digital camera 91, the fuel cell system 92 is pressed deeply into the camera by the pressure spring 10 provided inside the cell lid 11. Thus, an input electrode terminal (not illustrated) on the digital camera 91 side and an output electrode terminal (not illustrated) of the fuel cell system 92 are brought into electrical contact with each other.

The force of pressing the fuel cell system 92 of the pressure spring 10 is several kgf.

The fuel cell 1 has a fuel cell stack 3 including a plurality of layers of fuel cell units 30, as a power generation portion. The fuel cell unit 30 used herein is a polymer electrolyte fuel cell. On both ends of the fuel cell stack 3 having the fuel cell units stacked therein, there are provided a top plate 41 and an end plate 4 into contact therewith. Incidentally, in the fuel cell stack 3 in FIG. 1, for convenience of presentation, only the fuel cell units 30, 30 located at the both ends are illustrated and the intermediate fuel cell units are not illustrated, which is indicated by the two thin chain lines and the one thick chain line between the fuel cell units 30, 30 in FIG. 1.

The top plate 41, the end plate 4 and the fuel cell stack 3 are fastened with a stack fastening component (not illustrated) through holes penetrating the three members to thereby bring the top plate 41, the end plate 4, and the fuel cell stack 3 into close contact with each other.

The stack fastening component used in the present example is a M3 screw, which penetrates the top plate 41 and the fuel cell stack 3. Subsequently, the fastening component may be engaged with a female screw hole provided in the end plate 4, or may further go through a through-hole provided in the end plate 4 and is engaged with a nut (not illustrated) disposed at an outlet of through-hole, thereby apply a compressive force to between the top plate 41 and the end plate 4.

Each fuel cell unit 30 is constructed by stacking an electrode plate 31, an anode seal 32, an anode gas diffusion layer 33, an electrolyte membrane electrode assembly (MEA) 34, a cathode gas diffusion layer 35 and a cathode flow path forming member 36.

The fuel cell 1 according to the present invention is not limited to a stack formed of a plurality of fuel cell units 30 and may be formed of a single fuel cell unit 30. The number of stacking fuel cell units 30 is suitably determined depending on a desired output voltage value.

The electrode plate 31 is made of a stainless steel and has a thickness of 0.1 mm. The material is not limited thereto as long as it has high mechanical strength, electrical conductivity, and a surface roughness of 10 μm or less in terms of Ra. Further, the thickness is not limited the above-mentioned value as long as a proper mechanical strength is secured.

The anode seal 32 is a Viton rubber O-ring whose cross-sectional diameter is 1 mm. However, the material is not limited thereto as long as it bears a high temperature (about 120° C.), and the diameter is not limited thereto. Further, the shape of the seal 32 is not limited to an O-ring and may be a gasket.

The anode gas diffusion layer 33 has functions of diffusing an inflowing gas and serving as a current collector and is formed of a carbon porous member as a material.

The electrolyte membrane electrode assembly (MEA) 34 is formed of a film of Nafion (trade name; manufactured by DuPont) which carries, on both surfaces thereof, a Pt-carbon catalyst having platinum fine particles deposited on surfaces of carbon particles.

For the cathode electrode gas diffusion layer 35, a porous conductive member is used herein, however, it is sufficient for the layer to have high porosity and conductivity.

In the present example, as the material of the cathode flow path forming member 36, Viton rubber (trade name; manufactured by DuPont) is used. However, another material may also be used provided that the material can bear a high temperature (about 120° C.). Moreover, the typical thickness of the cathode flow path forming member 36 is 6 mm, but the thickness is not limited thereto provided that the thickness when the fastening pressure is applied is almost identical to the thickness of the cathode gas diffusion layer 35.

As the fuel tank 2 in the present example, a tank for storing and supplying hydrogen as a fuel of the fuel cell 1 is used.

The inside of the fuel tank 2 is filled with a hydrogen storage alloy such as a titanium-iron alloy or a lanthanum-nickel alloy, or a hydrogen storage material such as carbon nanotube, graphite nanofiber, or carbon nanohorn.

These materials can store hydrogen in an amount of about 10% by weight at a pressure of 0.3 MPa (G). In consideration of the volume of the fuel cell 1, the external dimension of the fuel tank 2 is set to 25 mm×30 mm×10 mm.

At this time, the energy stored in the fuel tank 2 is about 7.0 [W·hr], which is two or more times that of a lithium ion battery having the same volume. In the present example, as the hydrogen storage material 9 in the fuel tank 2, a lanthanum-nickel alloy is used.

Between the power generation portion of the fuel cell 1 and the fuel tank 2, there is provided a flow path for supplying fuel, which is structured so as to feed hydrogen as a fuel into the fuel cell stack 3. That is, the fuel outlet 6 of the fuel tank 2 is connected to the fuel inlet 5 having a fuel flow path function in the end plate 4 on the fuel tank 2 side of the fuel cell 1, whereby hydrogen as a fuel is fed into the fuel cell 1.

The connecting portion 50 composed of the fuel inlet 5 and the fuel outlet 6 is configured so as to have a repetitively connectable/disconnectable structure, and when connected, also to keep an airtight seal to thereby prevent hydrogen from leaking out of the system. The term “repetitively connectable/disconnectable structure” herein employed refers to such a structure that a member for connection is reversibly deformed or displaced to permit a plurality of times of connection and disconnection without any problem.

The removal of the fuel tank 2 from the fuel cell 1 can be performed by pulling out the fuel tank 2 with a force of several tens of kgf or less.

When the fuel tank 2 is disconnected from the fuel inlet 5, the fuel outlet 6 will be automatically closed, thus causing no hydrogen leakage.

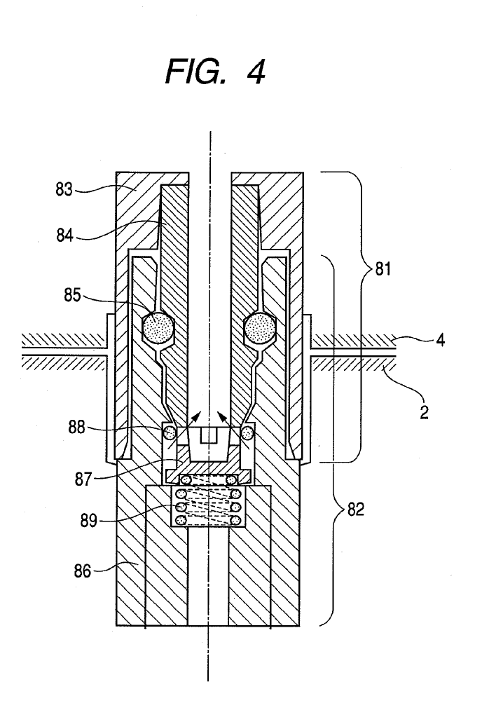

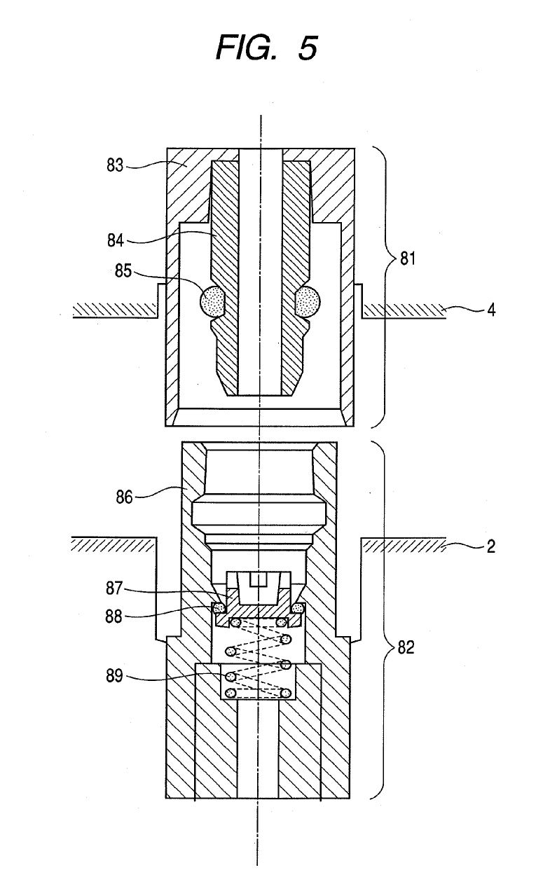

FIGS. 4 and 5 are enlarged cross-sectional views of the fuel inlet 5 and the fuel outlet 6.

FIG. 4 is an enlarged schematic cross-sectional view in a state where the fuel inlet 5 and the fuel outlet 6 are connected to each other.

FIG. 5 is an enlarged schematic cross-sectional view in a state where the fuel inlet 5 and the fuel outlet 6 are disconnected from each other.

The fuel inlet 5 is fitted with a socket 81. The socket 81 is adhered to the end plate 4. The socket 81 is composed of a socket guide 83 made of stainless steel, a socket pin 84, and a socket seal 85 which is a fluororubber O-ring.

A recess provided at an intermediate portion of the socket pin 84 covered with the socket guide 83 is fitted with the socket seal 85.

The fuel outlet 6 is fitted with a plug 82. The plug 82 is adhered to the fuel tank 2. The plug 82 is composed of a plug guide 86 and a plug valve 87 each made of stainless steel, a valve spring 89 made of Inconel (trade name; manufactured by International Nickel Company) alloy, and a valve seal 88 made of a fluororubber.

At the inner wall of the tubular plug guide 86, there is provided a recess into which the socket seal 85 fitting into the socket pin 84 fits.

Referring next to FIG. 4, the state of each component in a state where the fuel inlet 5 and the fuel outlet 6 are connected to each other will be described. In such a state, alignment is attained in a state where the socket seal 85 is interposed between the recesses of the socket pin 84 and the plug guide 86. At this time, the socket pin 84 pushes the plug valve 87 into the fuel tank 2 side, so that a flow path for hydrogen opens between the valve seal 88 and the plug valve 87 and hydrogen flows into the socket 81 side.

Referring next to FIG. 5, a state where the fuel inlet 5 and the fuel outlet 6 are disconnected from each other will be described. In such a state, the plug valve 87 is pushed out to the end plate 4 side by the valve spring 89, so that the valve seal 88 is interposed between the plug guide 86 and the plug valve 87 and the flow path for hydrogen is blocked.

When connecting or disconnecting the plug 82 to or from the socket 81, it is only necessary to push or pull the fuel tank 2 with a force larger than a frictional force between the socket seal 85 and the plug guide 86.

In the end plate 4, the fuel shut-off actuator 7 is disposed side by side with the fuel inlet 5. The fuel shut-off actuator 7 is composed of devices including a piston 71 and a cylinder mechanism that expands and contracts depending on temperature.

The direction of expansion and contraction of the fuel shut-off actuator 7 is the same as the removal direction of the fuel tank 2.

A mechanism for driving the piston 71 is required to reversibly move depending on temperature. As such a mechanism, a mechanism using a shape memory alloy or a bimetal can be used. In addition, a substance that absorbs or emits a gas accompanying phase transition caused by temperature can also be used. In the present example, description will be made by taking as an example a case where a hydrogen storage material 8 for driving which is sealed in a hydrogen storage state is used as such a substance.

Further, the term “predetermined temperature” herein employed is defined as follows. The term “predetermined temperature” is defined as a temperature at a location which may be exposed to abnormal heat generation in the fuel cell system at a temperature above which an allowable limit is exceeded. The predetermined temperature defined in this way is multiplied by a coefficient of heat transfer from the location which may be exposed to the heat generation to the fuel shut-off actuator 7 and a temperature at which the mechanism is to be driven is defined to set up the mechanism. Specifically, the composition and structure of a shape memory alloy or bimetal or the composition of the hydrogen storage material 8 for driving is determined in accordance with the temperature at which the mechanism is to be driven.

In the fuel shut-off actuator 7, the hydrogen storage material 8 for driving is sealed in hydrogen storage state.

With increase of the temperature of the periphery of the fuel shut-off actuator 7, the temperature of the hydrogen storage material 8 for driving rises to emit hydrogen, whereby the piston 71 is pushed out to extend the fuel shut-off actuator 7. Subsequently, when the temperature of the periphery of the fuel shut-off actuator 7 decreases and the temperature of the hydrogen storage material 8 for driving decreases, the hydrogen storage material 8 for driving absorbs hydrogen and the piston 71 is retracted to contract the fuel shut-off actuator 7.

The type of the hydrogen storage material 8 for driving is selected such that hydrogen is rapidly emitted to push the piston 71 when the temperature of the end plate 4 reaches around 80° C. in an ordinary use environment of the fuel cell 1. In addition, the amount of the hydrogen storage material 8 for driving is selected such that the piston 71 can apply a force which is higher than a total of a force of detaching the fuel tank 2 and a force of the pressure spring 10.

As the hydrogen storage material 8 for driving, a Ti—Fe alloy, a La—Ni alloy, a Ti—V—Cr alloy or the like may be used.

Next, the operation of the fuel shut-off actuator 7 according to the present example will be described below.

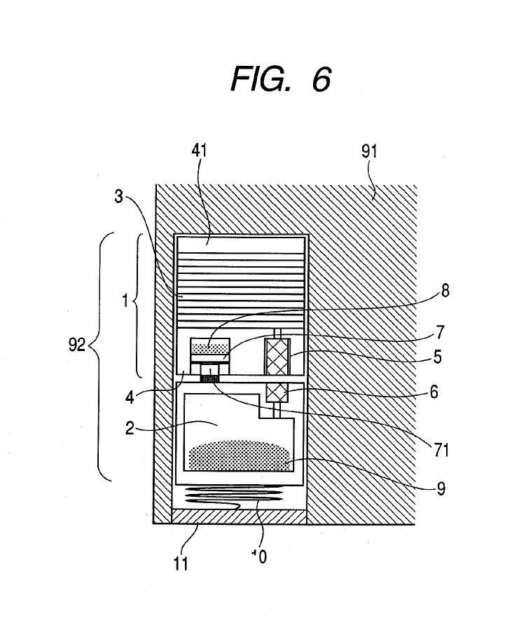

FIG. 6 is an enlarged schematic cross-sectional view illustrating a state in which the fuel shut-off actuator 7 according to the present embodiment operates.

According to the fuel cell system of the present example, when the temperature of the fuel cell 1 exceeds a predetermined temperature due to increase of ambient temperature of the fuel cell system 92 or abnormality of the fuel cell 1, the piston 71 is pushed out.

Specifically, heat is transferred from the end plate 4 to the fuel shut-off actuator 7 to warm the hydrogen storage material 8 for driving contained therein, whereby the hydrogen storage material 8 for driving emits hydrogen to push out the piston 71.

This produces a force of allowing the fuel shut-off actuator 7 to push out the fuel tank 2 and to disconnect the fuel inlet 5 of the fuel cell 1 and the fuel outlet 6 of the fuel tank 2 from each other.

Therefore, since the fuel supply to the fuel cell 1 from the fuel tank 2 is surely shut off, the fuel cell 1 can be prevented from causing performance degradation due to power generation in an abnormal high-temperature state.

At the same time, the displacement of the plug valve 87 can surely shut off fuel outflow from the fuel tank 2.

Moreover, since the amount of heat transfer from the fuel cell 1 to the fuel tank 2 is reduced, the increase in temperature of the hydrogen storage material 9 contained in the fuel tank 2 can be suppressed.

Furthermore, when the temperature of the fuel cell system 92 returns to normal temperature, the fuel inlet 5 and the fuel outlet 6 can be connected to each other.

More specifically, since the hydrogen storage material 8 for driving of the fuel shut-off actuator 7 absorbs hydrogen and the piston 71 contracts, the fuel inlet 5 of the fuel cell 1 and the fuel outlet 6 of the fuel tank 2 can be connected to each other again.

As described above, according to the present example, it is possible to surely cope with occurrence of an abnormal high-temperature state without using an expensive temperature sensor, control circuit or actuator.

In the present example, when the temperature of the fuel cell 1 exceeds a predetermined temperature, the fuel shut-off actuator 7 is driven through the end plate 4. However, a member with a high thermal conductivity may be separately disposed so as to be thermally coupled with a part of a fuel cell system or an electric device which is apt to be exposed to abnormal heat generation, thereby driving the actuator.

### Example 2

In Example 2, a structural example of a fuel cell system of a form different from the form of Example 1 will be described below.

In Example 1, a structural example in which the fuel shut-off actuator 7 is provided at the power generation portion has been described, while in the present example, a structural example in which the fuel shut-off actuator 7 is provided at a fuel supply portion will be described.

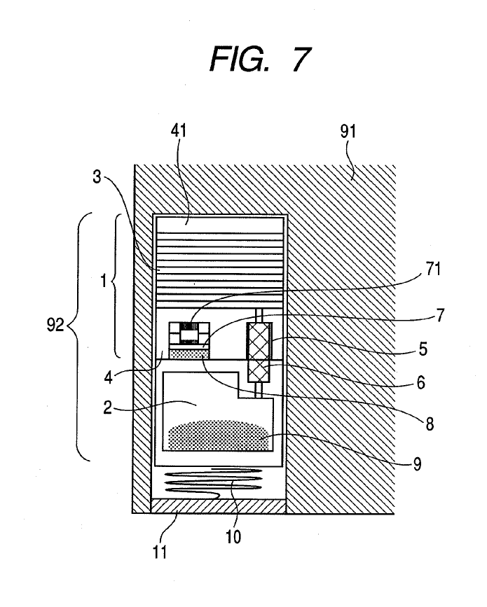

FIG. 7 is an enlarged schematic cross-sectional view illustrating an inner portion of the digital camera 91 used in the present example is loaded with the fuel cell system 92 as illustrated in FIG. 2.

In FIG. 7, the elements which are the same as those shown in FIG. 3 referred to in Example 1 are identified by like numerals. Accordingly, description of common elements will be omitted.

In the present example, the force of pressing the fuel cell system 92 of the pressure spring 10 is several kgf.

The structure of the fuel cell 1 is the same as that of Example 1.

In the end plate 4, the fuel shut-off actuator 7 is disposed side by side with the fuel inlet 5.

The fuel shut-off actuator 7 is a cylinder having a function of expanding and contracting depending on temperature. The direction of expansion and contraction of the fuel shut-off actuator 7 is the same as the removal direction of the fuel tank 2.

In the fuel shut-off actuator 7, the hydrogen storage material 8 for driving is sealed in hydrogen storage state.

With increase of the temperature of the periphery of the fuel shut-off actuator 7, the temperature of the hydrogen storage material 8 for driving rises to emit hydrogen, whereby the piston 71 is pushed out to extend the fuel shut-off actuator 7.

The piston 71 is made of a member with a high thermal conductivity such as aluminum.

Subsequently, when the temperature of the periphery of the fuel shut-off actuator 7 decreases and the temperature of the hydrogen storage material 8 for driving decreases, the hydrogen storage material 8 for driving stores hydrogen and the piston 71 is retracted to contract the fuel shut-off actuator 7.

The type of the hydrogen storage material 8 for driving is selected such that hydrogen is rapidly emitted to push the piston 71 when the temperature of the end plate 4 reaches around 80° C. in an ordinary use environment of the fuel cell 1. In addition, the amount of the hydrogen storage material 8 for driving is selected such that the piston 71 can apply a force which is higher than a total of a force of detaching the fuel tank 2 and a force of the pressure spring 10.

As the hydrogen storage material 8 for driving, a Ti—Fe alloy, a La—Ni alloy, a Ti—V—Cr alloy or the like may be used.

Next, the operation of the fuel shut-off actuator 7 according to the present example will be described below.

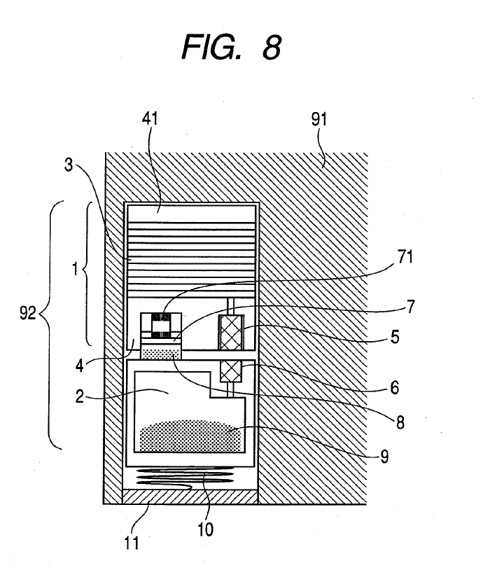

FIG. 8 is an enlarged schematic cross-sectional view illustrating a state in which the fuel shut-off actuator 7 according to the present embodiment operates.

According to the fuel cell system of the present example, when the temperature of the fuel cell 1 exceeds a predetermined temperature due to increase of ambient temperature of the fuel cell system 92 or abnormality of the fuel cell 1, the piston 71 is pushed out.

Specifically, heat is transferred from the end plate 4 to the fuel shut-off actuator 7 to warm the hydrogen storage material 8 for driving contained therein, whereby the hydrogen storage material 8 for driving emits hydrogen to push out the piston 71.

This produces a force of allowing the fuel shut-off actuator 7 to push out the fuel tank 2 and to disconnect the fuel inlet 5 of the fuel cell 1 and the fuel outlet 6 of the fuel tank 2 from each other.

Therefore, since the fuel supply to the fuel cell 1 from the fuel tank 2 is surely shut off, the fuel cell 1 can be prevented from causing performance degradation due to power generation in an abnormal high-temperature state.

At the same time, the displacement of the plug valve 87 can surely shut off fuel outflow from the fuel tank 2.

Moreover, since the amount of heat transfer from the fuel cell 1 to the fuel tank 2 is reduced, the increase in temperature of the hydrogen storage material 9 contained in the fuel tank 2 can be suppressed.

Furthermore, when the temperature of the fuel cell system 92 returns to normal temperature, the fuel inlet 5 and the fuel outlet 6 can be connected to each other.

More specifically, since the hydrogen storage material 8 for driving of the fuel shut-off actuator 7 absorbs hydrogen and the piston 71 contracts, the fuel inlet 5 of the fuel cell 1 and the fuel outlet 6 of the fuel tank 2 can be connected to each other again manually by an operator.

Furthermore, according to the present example, when filling the fuel tank 2 with hydrogen using a fuel tank filling equipment, even in the case where the temperature of the fuel tank 2 exceeds a predetermined temperature due to some abnormality, the filling operation can be automatically stopped.

As described above, according to the present example, it is possible to surely cope with occurrence of an abnormal high-temperature state without using an expensive temperature sensor, control circuit or actuator.

The fuel cell systems according to the above-described examples can surely shut off fuel and stop power generation to attain system protection, regardless of whether the fuel is gas or liquid, when the temperature of the fuel cell or the surroundings thereof becomes higher than a predetermined temperature. Thereby, the power generation of the fuel cell can be stopped to protect the fuel cell system. Further, when the temperature has later returned to normal temperature, the fuel supply can be started again to enable power generation.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-331195, filed Dec. 7, 2006, which is hereby incorporated by reference herein in its entirety.

What is claimed is:

1. A fuel cell system comprising:
a fuel cell having a power generation portion;
a fuel supply portion comprising a fuel tank for storing fuel for supply to the power generation portion;
a connecting portion configured such that a flow path provided between the power generation portion and the fuel supply portion, for supplying the fuel to the power generation portion is repetitively connectable/disconnectable; and
a fuel shut-off actuator configured such that the flow path is disconnectable at the connecting portion when a temperature of at least a part of the fuel cell system becomes higher than a predetermined temperature.

2. The fuel cell system according to claim 1, wherein the fuel shut-off actuator is provided at either one of the power generation portion and the fuel supply portion.

3. The fuel cell system according to claim 1, wherein the fuel shut-off actuator comprises a device comprising a piston-cylinder mechanism which expands and contracts depending on temperature.

4. The fuel cell system according to claim 1, wherein the fuel shut-off actuator comprises a substance that emits a gas accompanying phase transition caused by temperature.

5. The fuel cell system according to claim 4, wherein the substance is a hydrogen storage material for driving sealed in a hydrogen storage state.

6. A fuel cell system comprising:
a fuel cell;
a fuel tank;
a flow path for supplying fuel from the fuel tank to the fuel cell;
a connecting portion provided in the flow path and configured so as to be repetitively connectable/disconnectable;
a temperature sensor; and
an actuator for disconnecting the connecting portion in response to the temperature sensor.

7. The fuel cell system according to claim 6, wherein the actuator is configured so as to also serve as the temperature sensor.
